(19) United States
(12) Patent Application Publication
(10) Pub. No.: US 2009/0078658 A1
(43) Pub. Date: Mar. 26, 2009

(54) OIL FILTER ELEMENT OF WOUND COTTON/PAPER COMPOSITION

(75) Inventors: Mark T. Meddock, Oceanside, CA (US); Le Roy Meddock, Oceanside, CA (US); Paul DeSantis, Santa Monica, CA (US)

Correspondence Address: LEWIS, BRISBOIS, BISGAARD & SMITH LLP, 221 NORTH FIGUEROA STREET, SUITE 1200, LOS ANGELES, CA, 90012, US

(73) Assignee: Hepo Filters, Inc., Santa Monica, CA (US)

(21) Appl. No.: 12/184,880

(22) Filed: Aug. 1, 2008

Related U.S. Application Data
(63) Continuation-in-part of application No. 11/858,257, filed on Sep. 20, 2007.

(51) Int. Cl. B01D 37/00; B01D 29/33

(52) U.S. Cl. 210/767; 210/440; 29/428

(57) ABSTRACT

A filter element designed for engine oil lubrication and hydraulic oils, comprising a core having a hollow interior and a perforated outer surface, in fluid communication with the hollow interior, an open first end in fluid communication with the hollow interior, and a closed second end. The filter element comprises alternately wrapping one or more layers of flat sheet barrier filter material and, on top of the barrier filter material, winding, in a uniform winding pattern, one or more layers of cotton/cellulose composition yarn over the outer surface of the core, each layer having a progressively finer filtration as the oil moves radially from the exterior of the element inward towards the core.

This application is a continuation-in-part of U.S. patent application Ser. No. 11/858,257, filed Sep. 20, 2007.

### FIELD OF THE INVENTION

This invention relates generally to oil filtration, and more particularly to a method and filter element for filtering contaminants from internal combustion and industrial engine oil and hydraulic oil.

### BACKGROUND OF THE INVENTION

A typical full-flow engine filter system requires a high flow rate in the range of about ten to twenty gallons per minute. The full-flow filter's media is made of pleated paper or other conventional media, allowing the oil to flow rapidly through the media to avoid slowing the flow rate, which would stave the engine of lubrication oil and cause severe damage to the engine.

Because the full-flow filter cannot use a large quantity of finer media, the full-flow filter can only effectively remove particulate contaminants approximately 40 microns or larger. Harmful small, 1 to 25 micron clearance-sized particle contaminants are allowed to flow through the system. These abrasive, clearance-sized particle contaminants travel in the oil film between the moving lubricated parts, where they scrape and grind against the piston rings and cylinder bores, valve cross-heads, rockers, cam followers, rod bearings, valve train, gearing, piston pins, bushings, and other lubricated engine parts. Because the engine oil continuously recycles, clearance-sized particles are also recycled continuously, growing in numbers as the engine operates. Oil contaminated with clearance-sized particles create friction and engine wear, which requires the oil to be changed more frequently than desired. In addition, another drawback of the typical full-flow filter is that it does not absorb water moisture from the oil.

Vehicle owners often use an auxiliary bypass filter for additional filtering. A typical bypass filter retrofits to a vehicle engine where it diverts oil through a finer auxiliary filter element at a much slower rate (e.g., ¼ to 1 gallon per minute or less). Passing the oil through the denser media in the auxiliary filter element helps filter out particles smaller than 40 microns. That improves engine oil life and the life of the engine.

However, bypass filters have had certain problems that needed to be overcome. For example, many existing bypass filter elements are barrier or surface filters, in the sense that filtering occurs at just the outer surface of the element where the oil first enters the element. With barrier filters, particles tend to accumulate at the outer surface of the element, thereby loading the filter element and cutting off the flow of oil through it, sometimes referred to as element “filter caking”. As a result, filtering is degraded and the element must be changed more frequently than desired. In general, the higher the barrier-style filtration efficiency at the lower micron size, the shorter the element life, due to filter clogging on the surface of the barrier.

While depth-style elements typically do not clog on the surface as barrier-style filters do, many of the depth-style filters are structurally weak, which results in “channeling”, in the sense that the oil passes through the filter element along one or more channels or paths of less resistance. The filter element may initially have such paths of less resistance (a problem in rolled media filters made with cotton/synthetic fiber composition) or develop them over time (a problem of filters packed with cotton/synthetic fibers, sawdust, hulls, and other such media). Oil passing under pressure, at temperatures of 250° F. or higher, through the filter element seeks out the channels, and a breach in the surface of the filter element may even rupture the element, allowing the oil to flow through the filter without any filtering at all. In addition, depth-style elements must choose between a tight wind to achieve efficient, low micron filtration, which will load more quickly or choose a more open wind to increase element life, which will not provide high filtration at the lowest micron sizes. The above stated problems were solved by a filter element described in prior U.S. Pat. No. 5,552,065 issued Sep. 3, 1996, which provided different winding patterns to achieve staged, progressive filtration as the oil moves radially from the outer surface to the inner portion of the element.

This invention is an improvement on the filter element described in U.S. Pat. No. 5,552,065 and the filter element described in the parent to this application. The parent application provided for a filtering combination consisting of two or more barrier sections in the element with variable winding patterns. This application comprises additional embodiments, including one or more barrier sections with a uniform winding pattern. These additional embodiments provide additional flexibility and precision to optimize the barrier portion(s) and depth wound media portion of the element. These additional embodiments allow the element additional tailoring to different lubrication needs. For example, diesel engines produce heavy soot, which contaminates the oil, requiring more capacity in the depth portion(s) of the element, while the dryer combustion in natural gas CNG and LNG engines produce little soot, which allows the element to be optimized for finer filtration with finer barriers and a finer winding pattern.

The filter element described in the prior patent, U.S. Pat. No. 5,552,065, comprised a specially wound, cylindrically shaped variable depth filter element. The filter element had an elongated hollow core on which a length of yarn is wound in a multi-layered winding. The yarn is a composition of cotton and cellulose paper so that it absorbs water without the usual step of heating the oil. In addition, it is wound with an irregular winding pattern, such that layers near the core are adapted to filter particles down to a size of one micron and layers further out from the core are adapted to filter particles down to a size of 2-6 microns. A preferred embodiment included layers near the outer circumference of the filter element that are adapted to filter particles down to a size of 2-35 microns.

The petroleum-based or synthetic oil to be filtered passed radially through the multi-layered winding of the filter element, from the outer circumference of the filter element into the hollow core, and then axially through the hollow core back out of the canister. Different layers of the filter element trapped different size particles, ranging from about 25-40 microns at the outer circumference to about 2-6 microns near the core. The cotton-and-cellulose-paper composition of the yarn absorbs water, which aids to filter the oil more effectively.

The improved filter element of the parent application comprises a filter element in a canister having an inlet and an outlet. The filter element comprises;
1. A cylindrical cotton/cellulose yarn wound filter element comprising an inner perforated metal cylindrical core, which may optionally, be wrapped with a sheet of non-micron rated, migration barrier material. This material may be a natural material, such as felt, a microglass synthetic media, or other common material such as nylon, which prevents pieces of yarn from flowing into the engine. Then, depending upon the desired micron rating for the finished element, a first layer of 0.5-3 micron rated, flat sheet, filter material, the innermost layer, is wrapped around the core, or the migration barrier material if present, with one or more turns, which will provide a 0.5-3 micron surface barrier.
2. A second layer made of cotton/cellulose yarn is helically wound to a nominal rating matching, or slightly larger micron rating than the flat sheet filter material innermost first layer, to a cylindrical depth of about 0.500 inches to about 0.750 inches. The second layer will provide progressive depth filtration to the nominal desired rating of the element.
3. A third layer of 3 to 6 micron rated flat sheet material is then wrapped, with one or more turns around the second layer. The third layer will provide a 3 to 6 micron surface barrier.
4. A fourth layer of helically wound cotton/cellulose yarn wound to a nominal 6 to 15 micron rating, is wound around the third layer and wound to the final cylindrical diameter. This filter element design will provide progressive depth filtration through the outer layer to a nominal 6 to 15 microns.

### SUMMARY OF THE INVENTION

The additional embodiments of the filter element of this invention comprise a filter element for oil, such as hydraulic oil or lubricating oil, in a canister having an inlet and an outlet. The filter element comprises;
1. A cylindrical cotton/cellulose yarn wound filter element comprising an inner perforated metal cylindrical core, which may optionally be wrapped with a sheet of non-micron rated, migration barrier material. This material may be a natural material, such as felt, a micro glass synthetic media, or other common material such as nylon, which prevents pieces of yarn from flowing into the engine.
2. Then, there is one layer to four layers of barrier filter material. If there is one layer of barrier filter material, it may optionally be either the first layer or a layer in the middle portion of the element. If there is a first layer of barrier material, a flat sheet, barrier filter material, the innermost layer, is wrapped around the core, or the migration material if present, with one or more turns. The flat sheet material, if present, can be from about 0.5 to about 3 micron rated, which will provide a 0.5-3 micron surface barrier, depending upon the desired micron rating for the finished element. The barrier filter material may be made of a natural material, such as felt or a synthetic material, such as nylon.
3. A layer made of cotton/cellulose yarn is then helically wound to a nominal rating of from about 2 microns to about 8 microns, preferably from about 3 microns to about 6 microns. The cotton/cellulose yarn is wound in a uniform winding pattern to fill the canister or it may be wound to a partial cylindrical depth where a second optional flat sheet of barrier material, of the same, or slightly larger micron rating as the first sheet, from about 4 microns to about 7 microns, is wrapped, with one or more turns around the first layer of yarn, and then the cotton/cellulose yarn is then again wound, in the same uniform winding pattern around the second layer of flat sheet material, to fill the canister.
   If the first layer of yarn is partially wound in this step, it may be wound to a depth of from about 0.500 inches to about 0.750 inches.
   If desired, the second layer of yarn can also be uniformly wound to a partial depth and an optional additional layer of flat sheet material wound before the final layer of yarn is wound to fill the final cylindrical diameter of the canister. If the additional barrier material is not used, then the winding will continue to fill the cylindrical diameter of the canister.

The key differences between this invention and the filter element described in the parent application is that there can be one or two, or more, barriers and the yarn in the canister is wound with a uniform winding pattern throughout the filter element. The results have proved to provide close control and customization of the filtration by balancing the barrier and wound portions of the filter. In addition, the uniformly wound filter element of this invention is easier and less expensive to manufacture, because the winding machinery does not have to be stopped and reset to another winding pattern, and yet the uniform winding pattern, when used in conjunction with the appropriate barrier materials, provides at least equal or even superior results than other embodiments. This invention provides additional embodiments using one or more one or more layers of barrier materials without the need to change the winding pattern, as in the parent application. For instance, a uniform winding pattern, which provides approximate filtration down to 10 microns at the inner most portion and 25 microns at the outer most portions, is augmented with a 10-micron barrier in the middle of the element and a 2-micron barrier at the inner core of the element. This embodiment provides staged, progressive filtration with only one winding pattern.

### BRIEF DESCRIPTION OF THE DRAWINGS

FIG. 1 is a cross-sectional view showing a filter element constructed according to the invention;

FIG. 2 is a cross-sectional view of the filter element taken on lines 2-2 of FIG. 1.

### DESCRIPTION OF THE PREFERRED EMBODIMENTS

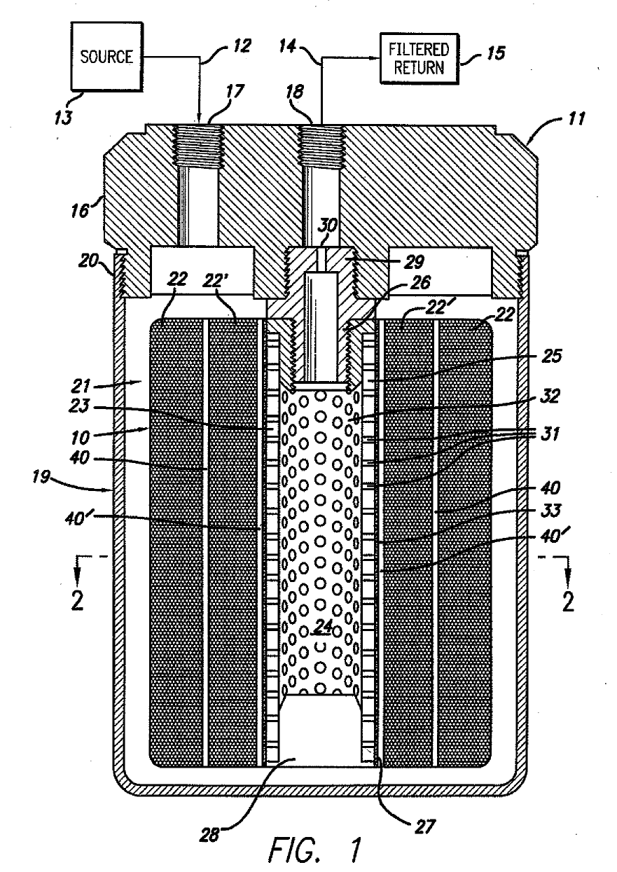

FIG. 1 of the drawings shows a filter element 10 constructed according to the invention. Filter element 10 is mounted in a canister assembly 11 that is connected, as shown diagrammatically in FIG. 1, via a first line 12, to a pressurized source 13 of oil (e.g., an auxiliary oil port on the block of an engine on a truck) and via a second line 14, to a return 15 (e.g., valve cover, oil filler pipe, or oil pan on the engine). Interconnected that way, filter element 10 is used according to the method of the invention to filter oil (e.g., provide additional filtering of truck engine oil).

Canister assembly 11 may be similar in some respects to known filter element containers used in other cartridge-based filter installations. It includes a cap 16 of metal, or other suitable composition, that mounts by suitable means on an available support structure. Cap 16 may mount under the hood of a truck next to the engine, or any other convenient location, for example. Cap 16 includes an inlet 17 to which line 12 connects by a known type of fitting or other suitable means (the details of which are not shown) and an outlet 18 to which line 14 connects by another fitting or other suitable means (not shown).

Canister assembly 11 also includes an upwardly opening canister 19, of steel or other suitable composition, with a threaded upper lip 20 that screws onto cap 16 and a hollow interior 21 in which filter element 10 fits. The user first mounts the filter element 10 on cap 16, and then screws the canister 19 onto cap 16 to complete the installation.

Although the size and shape of components may vary according to the precise installation, the illustrated filter element 10 is a generally cylindrically shaped component, typically having about a four-inch outside diameter and about an eight-inch axial length. Filter element 10 comprises layers of flat sheet, natural or synthetic filter media 40, 40′ and layers of yarn 22, 22′, wound in a multi-layered uniform winding, on an elongated, cylindrically shaped core 23, composed of steel or other suitably rigid material. Core 23 has a hollow interior 24, a first end 25 into which a first plug 26 is mounted in a force fit, and a second end 27 into which a second plug 28 is mounted in a force fit.

First plug 26 screws onto an adaptor component 29 that screws into cap 16. First plug 26 and adaptor component 29 thereby connect first end 25 and hollow interior 24 of core 23, in fluid communication with outlet 18 of cap 16, through an orifice 30 in adaptor component 29 that restricts the flow rate to a desired range. Meanwhile, second plug 28 closes second end 27 of core 23, and a series of openings 31 in core 23 form a perforated outer surface 32 of core 23, in fluid communication with hollow interior 24 of core 23. Only a few of the openings 31 are shown in FIG. 1 for illustrative convenience.

Oil from source 13 passes through line 12, into inlet 17 in cap 16, at about one to two quarts per minute. From there, the oil passes into interior 21 of canister 19. Next, the oil passes radially through the plurality of layers, subsequently described, of a multi-layered winding of yarn 22, then one or more turns of flat sheet, natural or synthetic filter material 40, a second multi-layered winding of yarn 22′, then another one or more turns of flat sheet, natural or synthetic filter material 40′ and thereafter through an optional sheet of non-micron rated, migration barrier material 33 covering the perforated surface 32 of core 23. Optional migration barrier material 33 forms a cylindrically shaped sleeve over core 23, between the flat sheet synthetic filter material 40′ and perforated surface 32, and is capable of passing particles smaller than 40 microns while trapping any cotton and paper particles breaking free from the yarn. Optional migration barrier material 33 may be a natural material, such as felt or a micro glass synthetic media, or other common material such as nylon, which prevents pieces of yarn from flowing into the engine.

The flat sheet filter material is made of a natural material, such as felt or a synthetic material, such as nylon, having the capacity to withstand at least 250 degrees F. hot oil and not lose structure or rupture when exposed to water.

After passing through filter paper 33, the oil passes through openings 31, into interior 24 of core 23. Next, the oil passes axially through core 23 towards first plug 26. Then the oil passes through first plug 26, adaptor component 29, outlet 18 in cap 16, through line 14 to return 15. As the oil follows the described path, particles in the oil are trapped in the many layers of yarn wound on core 23.

According to an aspect of the invention, the yarn is composed of a composition of cotton and cellulose paper and is wound with a uniform winding pattern. Using a known type of spinning machine, such as may be used in the textile trade for example, strands of carded cotton and toilet tissue are spun into about a 150 to about 180 grains per 12 yards length of yarn, preferably about 165 grains to about 170 grains per 12 yards, composed of about 5-25% cellulose paper (preferably about 5-10%). Then, using a known type of precision winding machine, such as may be used in the textile trade for winding bobbins for example, the length of yarn is wound in a uniform winding pattern, onto core 23.

Core 23 is mounted on the winding machine and rotated by the machine at a controlled rate while the yarn is fed through a head to core 23 so that it winds onto core 23. Meanwhile, the head is moved back and forth, parallel to the longitudinal axis of core 23. By varying the speed of rotation and the speed of the head, various winding patterns can be produced by the winding machine in a manner known by those of ordinary skill in the winding art. In the oil filter element of this invention the yarn 22 is wound on core 23 to form each of the yarn layers. Each of the yarn layers is uniform in winding pattern and density throughout the filter element. Uniformity in the winding pattern of the yarn layers saves time and expense because the winding machine does not have to stopped and reset to a different pattern, as must be done to create non-uniform winding patterns.

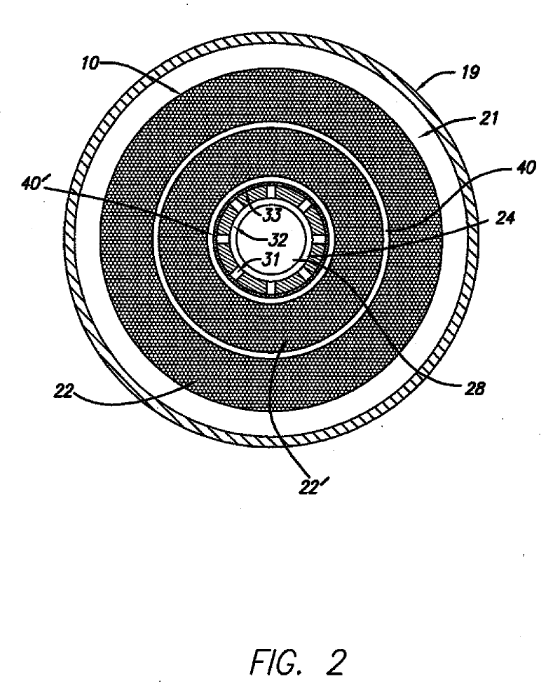

FIG. 2 uses lines to depict four layers 40, 22, 40′ and 22′, of filter element 10. Of those layers, flat sheet filter material layer 40′ is radially nearest core 23 while each one of the layers 22′, 40 and 22 is progressively further out from core 23 than the preceding layer. Layer 22 is the furthest from core 23 and defines the outer circumference of filter element 10. Optional migration barrier material 33, wrapped around core 23 between layer 22 and core 23, is a natural material, such as felt, a synthetic media, such as micro glass or other common material such as nylon, which prevents pieces of yarn from flowing into the engine.

The filter element may have any desired micron rating for the finished element, such as from 0.5 to 3 microns and the flat sheet, natural or synthetic filter media, and the wound yarn will provide a 0.5-3 micron surface barrier, as chosen by the manufacturer.

The layer or layers of cotton/cellulose yarn are each helically wound to a nominal rating, substantially the same or slightly larger micron rating as the flat sheet filter media, to a cylindrical depth of about 0.500 inches to about 0.750 inches.

There may be one or more layers of flat sheet filter media and one or more layers of spun yarn, to complete the element. The yarn layer is wound in the same winding pattern, throughout the element. It has been found that equal or improved filtration occurs using a uniform winding pattern, in certain combinations of barrier material throughout the element, as opposed to an element with layers of varying winding patterns.

The method proceeds by introducing the oil into the inlet of the canister under pressure at a flow rate in the range of from about one-half to about two quarts per minute. That is done so that the oil passes radially from an outer circumference of the filter element, through the layers of the filter element, and into the hollow core. The method of this invention thereby traps particulate matter in each layer of the filter element while absorbing water from the oil. The oil is then discharged from the hollow core back out of the outlet of the canister. When the oil achieves operating temperature of about 200 degrees F. and higher, the water begins to vaporize and is vented from the engine. The flat sheet filter material is made of filter material having the capacity to withstand at least 250 degrees F. hot oil and not lose structure or rupture when exposed to water.

In line with the above, a filter element constructed according to the invention includes a core having a hollow interior, a perforated outer surface in fluid communication with the hollow interior, an open first end in fluid communication with the hollow interior, and a closed second end. The filter element includes one or more layers of cotton/cellulose composition yarn wound over the outer surface of the core in a uniform winding pattern, such as that described above. The yarn layers are alternated with one or more layers of flat sheet filter media material disposed between the yarn layers, having a micron rating of the media the same or slightly smaller than the yarn winding.

According to still another aspect of the invention, the yarn may be spun using known textile equipment from carded cotton and conventional cellulose paper (e.g., toilet tissue), enabling a single filter element to absorb up to 100 cc of water.

Certain vehicles or equipment, such as construction equipment, typically need a higher flow rate and lower filtration. A natural gas transit bus, on the other hand, requires finer filtration. The ability to vary the micron rating in the flat sheet layers of filter material and the yarn windings, while uniform throughout a given filter element, allows the customization of the filter element according to various equipment needs.

Although an exemplary embodiment has been shown and described, one skilled in the art may make changes, modifications and substitutions without necessarily departing from the scope and spirit of the invention.

What is claimed is:

1. A method of filtering oil, comprising:
providing a filter element in a canister having an inlet and an outlet, the filter element having an elongated hollow core with a perforated outer surface;
said filter element comprising one or more alternating layers of flat sheet filter material and yarn;
said flat sheet filter material wrapped in one or more turns over the outer surface of the core;
said yarn wound over the outer surface of each layer of the flat sheet filter material;
said yarn having a uniform winding pattern throughout the filter element;
introducing the oil into the inlet of the canister under pressure so that the oil passes radially from an outer circumference of the filter element and through the layers of the filter element into the hollow core, to thereby trap particulate matter, and discharging the oil from the hollow core out of the outlet of the canister.

2. The method of filtering oil of claim 1 in which each layer of yarn has substantially the same or slightly larger micron rating than the barrier material under it.

3. The method of filtering oil of claim 1, in which said flat sheet filter material is made of a natural material or a synthetic material.

4. The method of filtering oil of claim 1 in which the yarn is made of a cotton and cellulose paper composition.

5. The method of filtering oil of claim 1 in which the flat sheet filter material is made of filter material having the capacity to withstand at least 250 degrees F. hot oil and not lose structure or rupture when exposed to water.

6. The method of filtering oil of claim 1 in which the filter element also comprises a sheet of migration barrier material which is wrapped around the perforated outer surface of the hollow core.

7. The method of filtering oil of claim 6 in which the sheet of migration barrier material is made of a natural material, such as felt, or a synthetic material such as microglass or nylon.

8. A filter element, comprising:
a core having a hollow interior, a perforated outer surface in fluid communication with the hollow interior, an open first end in fluid communication with the hollow interior, and a closed second end;
one or more alternate layers of flat sheet filter material and yarn;
said flat sheet filter material wrapped in one or more turns over the outer surface of the core;
said yarn being wound over the outer surface of each layer of said flat sheet filter material, said yarn having a winding pattern throughout the filter element.

9. The filter element of claim 8 in which each layer of flat sheet filter material and each layer of yarn has substantially the same, or slightly larger, micron rating than the media below it.

10. The filter element of claim 8, in which said flat sheet filter material is made of a natural material or a synthetic material.

11. The filter element of claim 8 further comprising a layer of migration, barrier material wrapped around the perforated outer surface of the hollow core.

12. The filter element of claim 11 in which the sheet of migration barrier material is made of a natural material, such as felt, or a synthetic material, such as microglass or nylon.

13. The filter element of claim 8, in which the yarn comprises cotton and cellulose paper.

14. The filter element of claim 8 in which the flat sheet filter material is made of a material having the capacity to withstand at least 250 degrees F. hot oil and not lose structure or rupture when exposed to water.

15. The filter element of claim 8, in which the micron rating of the filter material and yarn is from about 0.5 to about 3 microns.

16. The filter element of claim 8 in which there is one layer of flat sheet filter material and one layer of yarn

17. The filter element of claim 8 in which there are two layers of flat sheet filter material and two layers of yarn.

18. A method of fabricating a filter element for filtering oil, comprising:
providing a core with a hollow interior and a perforated outer surface in fluid communication with the hollow interior;
wrapping one or more layers of flat sheet filter material in one or more turns over the outer surface of the core;
winding one or more layers of yarn comprising cotton and cellulose paper over each layer of the flat sheet filter material in a uniform winding pattern;
each layer of yarn and flat sheet filter material having substantially the same micron rating.

19. The method of fabricating a filter element of claim 18 comprising wrapping one layer of flat sheet filter material and winding one layer of yarn.

20. The method of fabricating a filter element of claim 18 comprising wrapping two layers of flat sheet filter material and two layers of yarn.

21. The method of fabricating a filter element of claim 18 comprising wrapping three or more layers of flat sheet filter material and three or more layers of yarn.
